(19) United States
(12) Patent Application Publication
(10) Pub. No.: US 2016/0366071 A1
(43) Pub. Date: Dec. 15, 2016

(54) METHODS AND SYSTEMS FOR MULTIPLE GIGABIT ETHERNET LINK RECOVERY

(71) Applicant: Cisco Technology, Inc., San Jose, CA (US)

(72) Inventors: Ajith Chandran, Sunnyvale, CA (US); Kabiraj Sethi, Fremont, CA (US); Chandra Shekhara Rao V, Bangalore (IN); Eric Cheung, Union City, CA (US)

(21) Appl. No.: 14/735,459

(22) Filed: Jun. 10, 2015

(51) Int. Cl. H04L 12/931; H04L 12/26

(52) U.S. Cl. CPC H04L 49/352; H04L 43/08

(57) ABSTRACT

Disclosed herein are systems and methods of negotiating an acceptable speed for communication between at least two Ethernet devices connected by a link. In one aspect, the method monitors the link health and status and makes a speed choice decision based on the error rate and link partner capability.

### BACKGROUND

Many modern network-connectable, electronic devices require data connectivity. IP telephones, wireless LAN access points, Bluetooth access points, web cameras, digital still and video cameras, computers, tablets, liquid crystal displays, point-of-sale kiosks, network intercom systems, cellular telephones, security systems, gaming systems, etc. are examples of devices that require data connectivity. In many instances, data connectivity is provided through wired Ethernet as defined by its standards (IEEE 802.3 and its many variations and additions). Much of the wired Ethernet infrastructure utilizes Category 5 Enhanced (Cat 5e) cables. A Cat 5e cable is a twisted (copper) pair cable for carrying signals. The cable standard provides performance of up to 100 MHz and is suitable for 10BASE-T, 100BASE-TX (Fast Ethernet), and 1000BASE-T (Gigabit Ethernet). Generally, Cat 5e cable is used for linking Ethernet devices such as transceivers, repeaters, access points, and the like, up to a link distance of 100 meters or less. However, as Ethernet continues to evolve to higher speeds (e.g., 10 Giga-Bits per second (GBPS) and above), Cat 5e cable is unable to effectively and reliably carry data communications at these higher speeds, even at distances less than 100 meters.

For achieving 10 GBPS speed and above over 100-meter cable, it may be required to switch to expensive Cat 6a cables or make other infrastructure changes. Furthermore, technology is being introduced that allows Ethernet devices to operate at a plurality of speeds. For example, a single Ethernet transceiver may be able to operate at up to five separate speeds (e.g., 10 GBPS, 5 GBPS, 2.5 GBPS, 1 GBPS, 100 Mega-Bits Per second (MBPS)). To avoid having to make extensive and expensive infrastructure replacements, it is desired that these new devices be able to support existing Cat 5e link infrastructure and provide auto-negotiation of capability on such cables. For market adoptability, the switching infrastructure needs to be able to support speed more than 1 GBPS over existing cable infrastructure to support IEEE 802.11ac complaint Access Points.

Generally, the default configuration on some Ethernet switches is to have all capable speeds of the switch advertised to link partners. So, with a Cat 5e 100-meter cable and both link partners supporting 5-Speed Multiple Gigabit, the Ethernet network will not be able to settle down on an agreed speed. This is because the default maximum speed capable for both link partners is 10 GBPS, which is generally not achievable on Cat 5e cable. Even if the Ethernet network is able to settle down on a 10 GBPS speed, the 10 GBPS link integrity may not be optimal on Cat 5e at lengths over 100-meters.

Such constraints may be a frustrating experience for customer, as the Ethernet link will not come up or will not be error free unless user configures slower speeds on one of the ports. Therefore, systems and methods are desired that overcome challenges in the art, some of which are described above.

### SUMMARY

Disclosed herein are systems and methods of negotiating an acceptable speed for communication between at least two Ethernet devices connected by a link. In one aspect, the method monitors the link health and status and makes a speed choice decision based on the error rate and link partner capability.

In one implementation, a method is described that comprises providing a first Ethernet device, wherein the first Ethernet device can be switched to be operable at any one of a plurality of speeds; providing a second Ethernet device that can be switched to be operated at one of one or more speeds; providing a link between the first Ethernet device and the second Ethernet device, wherein at least a portion of the link comprises a Category 5 Enhanced (Cat 5e) cable; and negotiating an operating speed for communication between the first Ethernet device and the second Ethernet device over the link, wherein the operating speed is one of the any one of the plurality of speeds of the first Ethernet device and one of the one or more speeds of the second Ethernet device.

In one implementation, the first Ethernet device and/or the second Ethernet device comprise an Ethernet transceiver.

Optionally, the first Ethernet device and/or the second Ethernet device can be switched to be operable at any one of the plurality of speeds they are capable of operating at through software. Optionally, at least a portion of the software is executing on the first Ethernet device.

In one implementation, the first Ethernet device and/or the second Ethernet device can be switched to be operable at any one of five different speeds. For example, the first Ethernet device and/or the second Ethernet device can be switched to be operable at any one of 100 Mega-Bits per second (MBPS), 1 Giga-Bit per second (GBPS), 2.5 GBPS, 5 GBPS and 10 GBPS speed.

In one implementation, at least a portion of the link comprising a Category 5 Enhanced (Cat 5e) cable comprises providing a 100 meter or less portion of the link comprised of Cat 5e cable.

In one implementation, negotiating the operating speed for communication between the first Ethernet device and the second Ethernet device over the link comprises: (a) setting the first Ethernet device at a selected speed, wherein the selected speed is one of the plurality of speeds of the first Ethernet device; (b) determining one or more of a link status, whether the second Ethernet device can operate at the selected speed, and channel characteristics at the selected speed; (c) making a decision to set the operating speed as the selected speed based on the one or more of the determinations; or (d) selecting another of the one or more of the plurality of speeds of the first Ethernet device and repeating (a)-(c), above. In one implementation, the selected speed and the selected another of the one or more of the plurality of speeds of the first Ethernet device are selected in order from fastest to slowest speeds.

In one implementation, making the decision to set the operating speed as the selected speed based on one or more of the determinations comprises making the decision to set the operating speed as the selected speed based on whether one or more of the determined channel characteristics at the selected speed are within an acceptable level as compared to threshold levels set for the channel characteristics. The channel characteristics can comprise Signal-to-Noise-Ratio (SNR), low-density parity-check (LDPC) errors, cyclic redundancy check (CRC) errors, symbol errors, frame check sequence (FCS) errors, collision fragments, line or system side receive or transmit bad packet counters, transmit total bytes and received total bytes used to calculate and store transmit and receive packet error rates (PERs), and the like.

Also described herein is an implementation of a system. In one implementation, the system is comprised of a first Ethernet device, wherein the first Ethernet device can be switched to be operable at any one of a plurality of speeds; a second Ethernet device that can be switched to be operated at one of one or more speeds; a link between the first Ethernet device and the second Ethernet device, wherein at least a portion of the link comprises a Category 5 Enhanced (Cat 5e) cable; and a processor, wherein the processor is communicatively coupled with the first Ethernet device and the second Ethernet device. The processor executes computer-readable instructions to negotiate an operating speed for communication between the first Ethernet device and the second Ethernet device over the link, wherein the operating speed is one of the any one of the plurality of speeds of the first Ethernet device and one of the one or more speeds of the second Ethernet device.

In one implementation, the first Ethernet device and/or the second Ethernet device comprise an Ethernet transceiver. Optionally, the processor can be associated with the Ethernet transceiver of the first and/or the second Ethernet device. The processor can execute computer-readable instructions to switch the first Ethernet device and/or the second Ethernet device to be operable at any one of the plurality of speeds the devices are capable of operating. In one implementation, the first Ethernet device and/or the second Ethernet device can be switched by the processor to be operable at any one of five different speeds. For example, the first Ethernet device and/or the second Ethernet device can be switched to be operable at any one of 100 MBPS, 1 GBPS, 2.5 GBPS, 5 GBPS and 10 GBPS speed.

In one implementation, the link comprises 100 meters or less of Cat 5e cable.

In one implementation the processor executing computer-readable instructions to negotiate an operating speed for communication between the first Ethernet device and the second Ethernet device over the link comprises the processor executing computer-readable instructions to: (a) set the first Ethernet device at a selected speed, wherein the selected speed is one of the plurality of speeds of the first Ethernet device; (b) determine one or more of a link status, whether the second Ethernet device can operate at the selected speed, and channel characteristics at the selected speed; (c) make a decision to set the operating speed as the selected speed based on the one or more of the determinations; or (d) select another of the one or more of the plurality of speeds of the first Ethernet device as the selected speed and repeat (a)-(c), above. In one implementation, the selected speed of the first Ethernet device and the selected another of the one or more of the plurality of speeds of the first Ethernet device are selected in order from 10 GBPS to 5 GBPS to 2.5 GBPS.

In one implementation, making the decision to set the operating speed as the selected speed based on the one or more of the determinations comprises making the decision to set the operating speed as the selected speed based on whether one or more of the determined channel characteristics at the selected speed are within an acceptable level as compared to threshold levels set for the channel characteristics. The channel characteristics comprising Signal-to-Noise-Ratio (SNR), low-density parity-check (LDPC) errors, cyclic redundancy check (CRC) errors, symbol errors, frame check sequence (FCS) errors, collision fragments, line or system side receive or transmit bad packet counters, transmit total bytes and received total bytes used to calculate and store transmit and receive packet error rates (PERs), and the like.

Yet another implementation described herein comprises a computer-readable medium comprising computer-executable instructions thereon that when executed cause a processor to negotiate an operating speed for communication between a first Ethernet device that can be switched to be operable at any one of a plurality of speeds and a second Ethernet device that can be switched to be operated at one of one or more speeds, said first Ethernet device and said second Ethernet device connected over a link, wherein at least a portion of the link comprises a Category 5 Enhanced (Cat 5e) cable. The computer-executable instructions comprise: (a) setting the first Ethernet device at a selected speed, wherein the selected speed is one of the plurality of speeds of the first Ethernet device; (b) determining one or more of a link status, whether the second Ethernet device can operate at the selected speed, and channel characteristics at the selected speed; (c) making a decision to set the operating speed as the selected speed based on the one or more of the determinations; or (d) selecting another of the one or more of the plurality of speeds of the first Ethernet device as the selected speed and repeat (a)-(c), above.

In one implementation, the selected speed of the first Ethernet device and the selected another of the one or more of the plurality of speeds of the first Ethernet device are selected in order from 10 GBPS to 5 GBPS to 2.5 GBPS.

In one implementation, making the decision to set the operating speed as the selected speed based on the one or more of the determinations comprises making the decision to set the operating speed as the selected speed based on whether one or more of the determined channel characteristics at the selected speed are within an acceptable level as compared to threshold levels set for the channel characteristics. The channel characteristics comprising Signal-to-Noise-Ratio (SNR), low-density parity-check (LDPC) errors, cyclic redundancy check (CRC) errors, symbol errors, frame check sequence (FCS) errors, collision fragments, line or system side receive or transmit bad packet counters, transmit total bytes and received total bytes used to calculate and store transmit and receive packet error rates (PERs), and the like.

Other apparatuses, methods, features and/or advantages will be or may become apparent to one with skill in the art upon examination of the following drawings and detailed description. It is intended that all such additional apparatuses, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIGS. 1A-1D illustrate simplified block diagrams of systems for multiple gigabit Ethernet link recovery;

FIG. 2A illustrates an example flow diagram of a method for multiple gigabit Ethernet link recovery according to one example implementation of the invention;

FIG. 2B is an example flow diagram that provides additional detail regarding negotiating an operating speed for communication between the first Ethernet device and the second Ethernet device over the link;

FIG. 3 illustrates an example flow diagram of a method for multiple gigabit Ethernet link recovery according to another implementation of the invention;

FIG. 4 is a non-limiting example of pseudocode that can be implemented to perform the process described in relation to FIG. 3; and

FIG. 5 illustrates an example computing device upon which embodiments of the invention may be implemented.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for a charging power storage device in a power over Ethernet environment, it will become evident to those skilled in the art that the implementations are not limited thereto.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

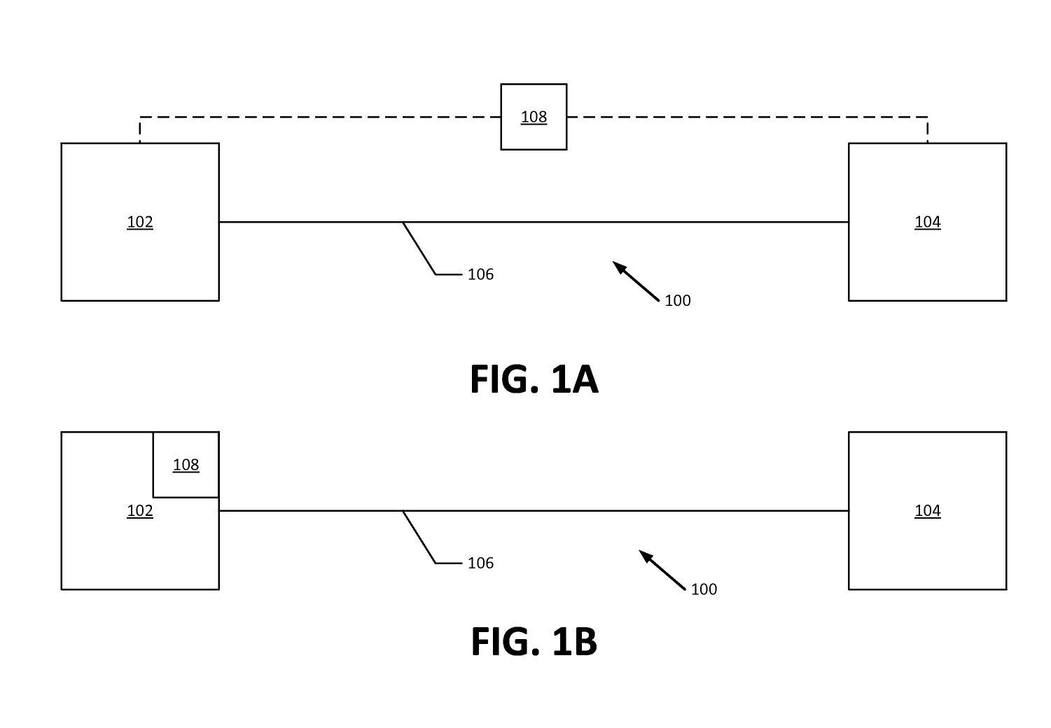

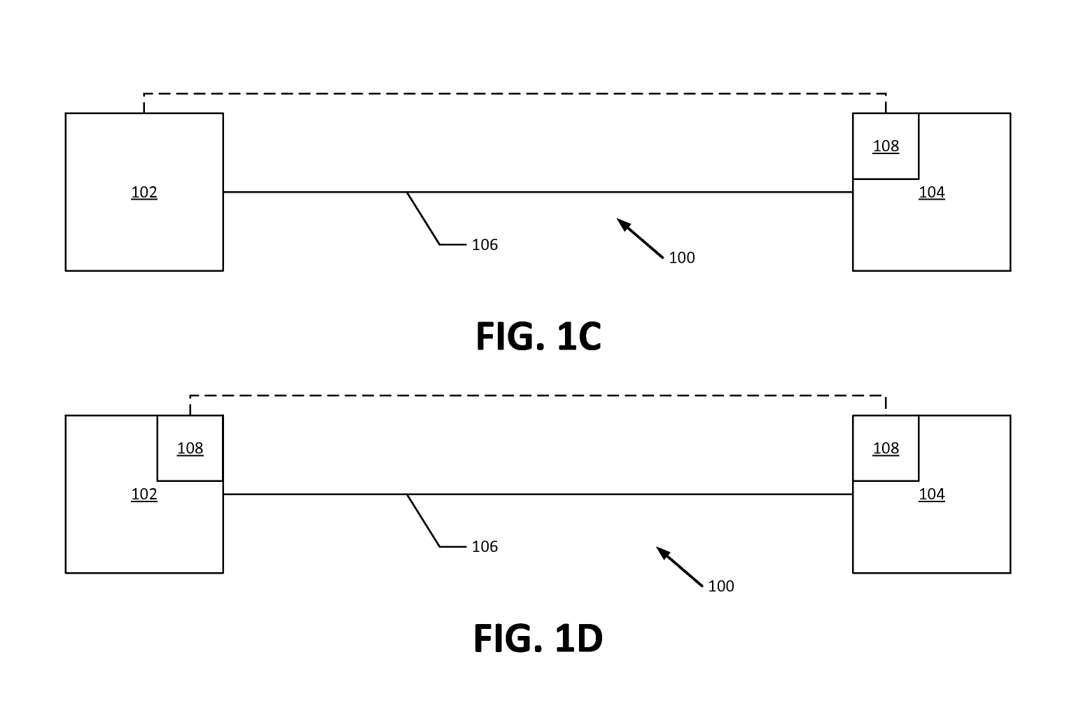

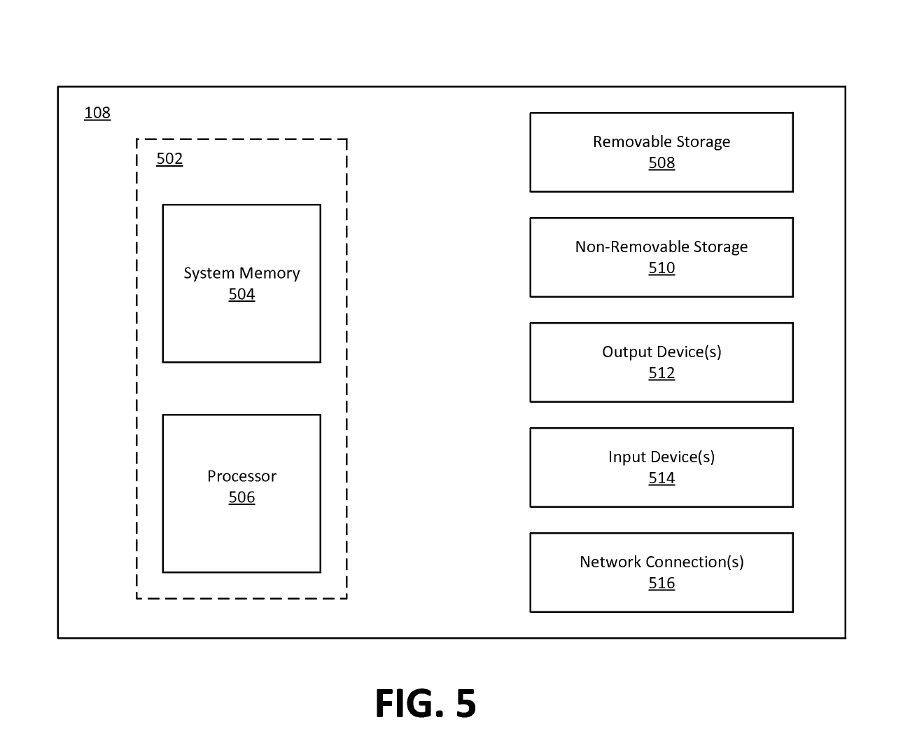

Referring to FIGS. 1A through 1D, simplified block diagrams of systems for multiple gigabit Ethernet link recovery are illustrated. A portion of an Ethernet-based data communications network is shown in FIG. 1A. One embodiment of the system 100 comprises a first data transmission and/or reception device (i.e., a first Ethernet device) 102, a second data transmission and/or reception device (i.e., a second Ethernet device) 104, a link that connects powered device 106, and a processing unit 108 that includes at least a processor. Additional details regarding the processing unit 108 can be found in relation to FIG. 5, herein. Each of the first Ethernet device 102 or the second Ethernet device 104 may be an Ethernet switch, an Ethernet transceiver, a computer connected to the Ethernet network, or any other device having an Ethernet interface and capable of receiving and/or transmitting data across the link 106. The first Ethernet device 102 and the second Ethernet device 104 can also be referred to as link partners, where the second Ethernet device 104 is a link partner to the first Ethernet device 102, and the first Ethernet device 102 is a link partner to the second Ethernet device 104. The link 106 that connects the first Ethernet device 102 and the second Ethernet device 104 can be comprised of a network cable and at least a portion of the link 106 is comprised of Category 5 Enhanced (Cat 5e) network cable. In one aspect, the link 106 has a portion that is comprised of Cat 5e cable that is 100 meters or less

Generally, one or both of the first Ethernet device 102 and the second Ethernet device 104 can be switched to operate at one of a plurality of speeds. In one example, the first Ethernet device 102 and the second Ethernet device 104 can receive and/or transmit data at one of five different speeds such as 100 Mega-Bits per second (MBPS), 1 Giga-Bit per second (GBPS), 2.5 GBPS, 5 GBPS and 10 GBPS. In another example, the first Ethernet device 102 can receive and/or transmit data at one of five different speeds and the second Ethernet device 104 (or vice versa) can receive and/or transmit data at one of two different speeds. For example, the first Ethernet device 102 can receive and/or transmit data at one of 100 MBPS, 1 GBPS, 2.5 GBPS, 5 GBPS and 10 GBPS, while the second Ethernet device can receive and/or transmit data at 1 GBPS or 10 GBPS. Generally, either the first Ethernet device 102 or the second Ethernet device 104 are switchable between their speeds using software. For example, a processor such as a processor that comprises processing unit 108 can be used to execute computer-executable instructions to cause either first Ethernet device 102 or second Ethernet device 104 to switch between the different speeds that either is capable of operating. In one embodiment, the processor of the processing unit 108 is communicatively coupled with at least one of the first Ethernet device 102 and the second Ethernet device 104. Such communicative coupling can be through one or more of a direct (wired) connection (including fiber optics), wireless (e.g., RF, infrared, etc.), or combinations of wired and wireless. In one example, the first Ethernet device 102 and the second Ethernet device 104 can communicate with one another over the link 106. The processor can execute computer-readable instructions to negotiate an operating speed for communication between the first Ethernet device 102 and the second Ethernet device 104 over the link 106, wherein the operating speed is one of the any one of the plurality of speeds of the first Ethernet device 102 and one of the one or more speeds of the second Ethernet device 104.

As shown in FIG. 1A, the processor of the processing unit 108 can be associated with and communicatively coupled with both, the first Ethernet device 102 and the second Ethernet device 104; or, referring to FIG. 1B, the processor of the processing unit 108 can be associated with and communicatively coupled with only one of the first Ethernet device 102 or the second Ethernet device 104 (information about the other Ethernet device (the second Ethernet device 104 in this example) may be programmed or stored into the processing unit 108 or memory of a separate control system and the other Ethernet device may be controlled (e.g., switch speeds, etc.) by the separate control system or by control signals sent from, for example, the processing unit 108 through the link 106 to the second Ethernet device 104). FIG. 1C illustrates an exemplary system embodiment where the processing unit 108 is associated with one of the Ethernet devices (device 104, in this example), but is communicatively coupled with the other Ethernet device (device 102, in this example). FIG. 1D illustrates an exemplary system where both the first Ethernet device 102 and the second Ethernet device 104 have separate processing units 108 that are communicatively coupled with one another. FIGS. 1A-1D only illustrate some of the configurations of a system 100 that can be used to perform the described methods and functions and are not intended to be exhaustive or limiting in any way.

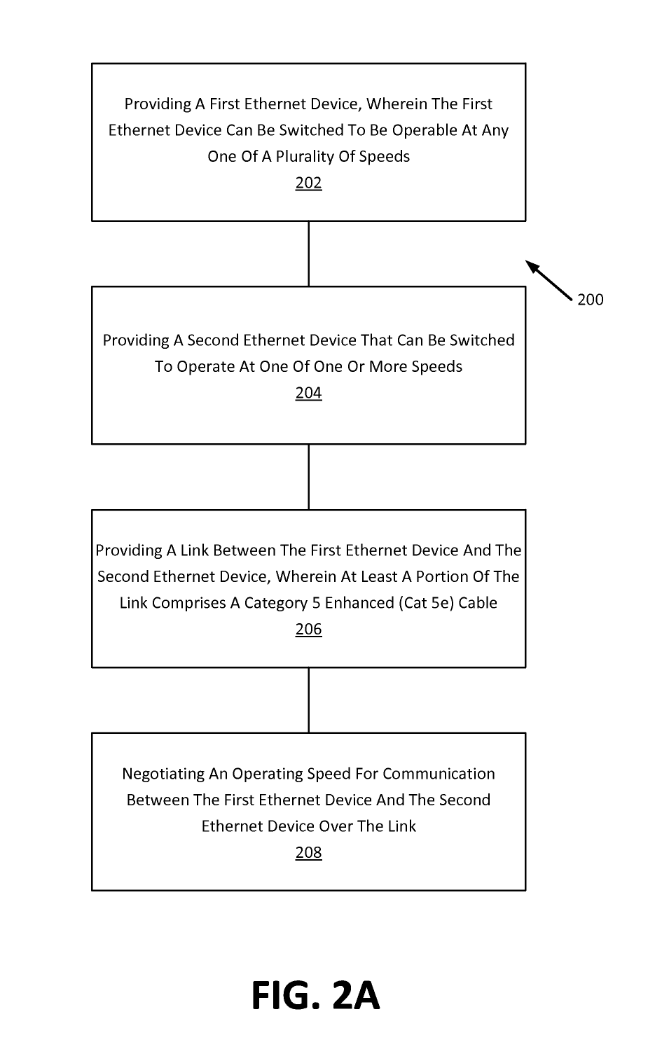

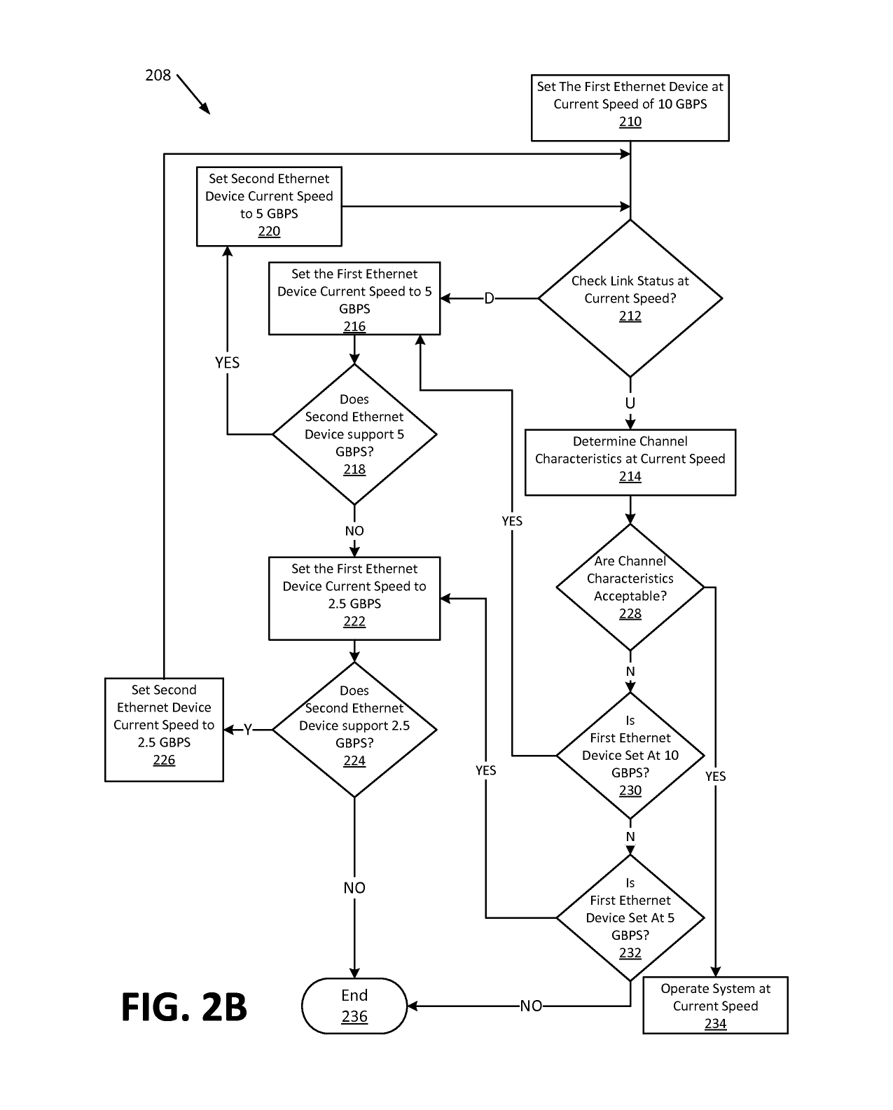

FIG. 2A illustrates an example flow diagram of a method 200 for multiple gigabit Ethernet link recovery according to one example implementation of the invention. Some of the aspects of the disclosed method 200 can be performed by a processor such as the processor described in relation to processing unit 108. At 202, a first Ethernet device is provided. The first Ethernet device can be switched to be operable at one of a plurality of speeds. For example, the first Ethernet device can be the first Ethernet device 102 as described above in relation to FIGS. 1A-1D. As noted herein, the first Ethernet device can comprise one or multiple devices, including an Ethernet transceiver. In one aspect, the first Ethernet device can be switched to be operable at any one of the plurality of speeds through software. In one aspect, at least a portion of the software for switching the first Ethernet device between speeds can be executing on the first or the second Ethernet device. In one aspect, as described herein, the first Ethernet device can be switched to be operable between five separate speeds such as, for example, any one of 100 MBPS, 1 GBPS, 2.5 GBPS, 5 GBPS and 10 GBPS.

At 204 of the flow diagram, a second Ethernet device is provided. The second Ethernet device can advertise to operate at one of one or more speeds. For example, the second Ethernet device can be the second Ethernet device 104 as described above in relation to FIGS. 1A-1D. As noted herein, the second Ethernet device can comprise one or multiple devices, including an Ethernet transceiver. In one aspect, the second Ethernet device can advertise to be operable at any one of the plurality of speeds through software. In one aspect, at least a portion of the software for switching the second Ethernet device between speeds can be executing on the first or the second Ethernet device. In one aspect, as described herein, the second Ethernet device can be switched to be operable between five separate speeds such as, for example, one of 100 MBPS, 1 GBPS, 2.5 GBPS, 5 GBPS and 10 GBPS.

At 206, a link is provided between the first Ethernet device and the second Ethernet device. At least a portion of the link comprises a Category 5 Enhanced (Cat 5e) cable. For example, the link can comprise 100 meters or less of Cat 5e cable.

At 208, an operating speed for communication between the first Ethernet device and the second Ethernet device over the link is negotiated. The negotiated operating speed can be one of the any one of the plurality of speeds of the first Ethernet device and one of the one or more speeds of the second Ethernet device. Generally, in one aspect, the process of negotiating the operating speed for communication between the first Ethernet device and the second Ethernet device over the link comprises: (a) setting the first Ethernet device at a selected speed, wherein the selected speed is one of the plurality of speeds of the first Ethernet device; (b) determining one or more of a link status, whether the second Ethernet device can operate at the selected speed, and channel characteristics at the selected speed; (c) making a decision to set the operating speed as the selected speed based on the one or more of the determinations; or (d) selecting another of the one or more of the plurality of speeds of the first Ethernet device and repeating (a)-(c), above.

Generally, the selected speed and the selected another of the one or more of the plurality of speeds of the first Ethernet device are selected in order from fastest to slowest speeds. For example, if the first Ethernet device were capable of operating at five separate speeds (e.g., 100 MBPS, 1 GBPS, 2.5 GBPS, 5 GBPS and 10 GBPS), the first speed selected to attempt to communicate with the second Ethernet device would be 10 GBPS. If the two Ethernet devices were unable to communicate over the link at 10 GBPS based on the determinations, then the first Ethernet device checks the advertised speeds for the second Ethernet device. If the second Ethernet device's advertisement list includes either 5 GBPS or 2.5 GBPS, or both, the first Ethernet device removes 10 GBPS from its supported list if it sees the second Ethernet device supports 5 GBPS. The next speed selected for the first Ethernet device to attempt to communicate with the second Ethernet device would be 10 GBPS 5 GBPS if the second Ethernet device support 5 GBPS. If second Ethernet device does not support 5 GBPS but supports 2.5 GBPS, then the first Ethernet device selects 2.5 GBPS speed to attempt to communicate with the second Ethernet device. This process stops after just one level of down shifting of supported speed attempt is made or after an acceptable speed is selected, based on the determinations, or until it is determined that the two Ethernet devices are unable to effectively communicate over the link. In such an instance where the two Ethernet devices cannot negotiate an acceptable speed, the link may have to be replaced with a new material such as a Cat 6a cable or better, or other physical level changes made to the system.

FIG. 2B is an example flow diagram that provides additional detail regarding negotiating an operating speed for communication between the first Ethernet device and the second Ethernet device over the link. At 210, the current speed of the first Ethernet device is set at its fastest operable speed, 10 GBPS. At 212, the link status at the current speed is checked. Generally, this involves determining whether the first Ethernet device and the second Ethernet device can communicate with one another over the link at the current speed or whether there is continuity in the link. A link status check can indicate whether the physical link along with datalink layer of the system is ready for communication or not. If the link status indicates “D” (for “DOWN”) then the link is not ready for data communication. The “DOWN” status may also indicate there is no physical connection. If the link status indicates “U” (for “UP”) then the physical connection exists between the local and remote network devices and the Ethernet link is good for data communication.

If, at 212, the link status is determined to be “DOWN,” then at 216 the current speed of the first Ethernet device is set at 5 GBPS. As described herein, this switching can be performed by software executing on a processor. At 218, it is determined whether the second Ethernet device can support 5 GBPS. Generally, this comprises checking an advertisement register of the second Ethernet device to see if the second Ethernet device supports the 5 GBPS speed. If, at 218 it is determined that the second Ethernet device supports 5 GBPS speed, then at 220, the second Ethernet device is set at a speed of 5 GBPS and the process returns to 212. If, at 218, it is determined that the second Ethernet device cannot support 5 GBPS, then at 222 the speed of the first Ethernet device is set a 2.5 GBPS. At 224, it is determined whether the second Ethernet device can support 5 GBPS. Generally, this comprises checking an advertisement register of the second Ethernet device to see if the second Ethernet device supports the 2.5 GBPS speed, or the information may have been previously stored by the processor performing the checking and switching. If, at 224 it is determined that the second Ethernet device supports 2.5 GBPS speed, then at 226, the second Ethernet device is set at a speed of 2.5 GBPS and the process returns to 212. If, at 224, it is determined that the second Ethernet device cannot support 2.5 GBPS, then the process ends at 236. In such an instance where the two Ethernet devices cannot negotiate an acceptable speed, the link may have to be replaced with a new material such as Cat 6a cable, or better, or other physical level changes made to the system.

Returning to 212, if, at 212, the link status is determined to be “UP,” then at 214 channel characteristics at determined at the current speed (where “current speed” can be any one of 10, GBPS, 5 GBPS, or 2.5 GBPS, as determined by blocks 210 and 216-226). The channel characteristics are determined for the communication channel between the first Ethernet device and the second Ethernet device. Generally, these characteristics go to the quality of the communication channel and can include, for example, Signal-to-Noise-Ratio (SNR), low-density parity-check (LDPC) errors, cyclic redundancy check (CRC) errors, symbol errors, frame check sequence (FCS) errors, collision fragments, line or system side receive or transmit bad packet counters, transmit total bytes and received total bytes used to calculate and store transmit and receive packet error rates (PERs), and the like.

Generally, at 228, threshold levels have been set for the channel characteristics and it is determined whether the specific characteristic falls within an acceptable level as compared to the threshold. If, at 228, the characteristics are within acceptable levels or if a sufficient number of the characteristics are within acceptable levels, then at 234 the system is operated at the current speed. If, at 228 it is determined that the channel characteristics are not acceptable, then the process goes to 230, where it is determined whether the first Ethernet device is set at 10 GBPS. If, at 230, the first Ethernet device is set at 10 GBPS, then the process goes to 216 where the first Ethernet device is set to a current speed of 5 GBPS and the process described above in relation to blocks 218-226 and block 234 occurs. If, at 230, it is determined that the first Ethernet device is not set at 10 GBPS, then the process goes to 232 where it is determined whether the first Ethernet device is set at 5 GBPS. If, at 232, the first Ethernet device is set at 5 GBPS, then the process goes to 222 where the first Ethernet device is set to a current speed of 2.5 GBPS and the process described above in relation to blocks 224, 226 and 234 occurs. If, at 232, it is determined that the first Ethernet device is not set at 5 GBPS, then the process goes to 236 where it ends. In such an instance where the two Ethernet devices cannot negotiate an acceptable speed with acceptable channel characteristics, the link may have to be replaced with a new material such as Cat 6a cable, or better, or other physical level changes made to the system.

In summary, the iterative process illustrated in FIG. 2B can be described as follows. Negotiating the operating speed for communication between the first Ethernet device and the second Ethernet device over the link can comprise: (a) setting the first Ethernet device at a selected speed of 10 GBPS; (b) determining a link status for the link between the first Ethernet device and the second Ethernet device at the selected speed of 10 GBPS; (c) if, at (b), the link status for the link between the first Ethernet device and the second Ethernet device is down at the selected speed of 10 GBPS, then (i) setting the selected speed of the first Ethernet device at 5 GBPS; (ii) determining whether the second Ethernet device supports the selected speed of 5 GBPS; (iii) if the second Ethernet device supports the selected speed of 5 GBPS, then setting the selected speed of the second Ethernet device at 5 GBPS; (iv) determining a link status for the link between the first Ethernet device and the second Ethernet device at the selected speed of 5 GBPS; (v) if, at (iv), the link status for the link between the first Ethernet device and the second Ethernet device is down at the selected speed of 5 GBPS, then: (A) setting the selected speed of the first Ethernet device at 2.5 GBPS; (B) determining whether the second Ethernet device supports the selected speed of 2.5 GBPS; (C) if, at (B), the second Ethernet device supports the selected speed of 2.5 GBPS, then setting the selected speed of the second Ethernet device at 2.5 GBPS and determining a link status for the link between the first Ethernet device and the second Ethernet device at the selected speed of 2.5 GBPS; (D) if, at (C), the link status for the link between the first Ethernet device and the second Ethernet device is down at the selected speed of 2.5 GBPS, then end negotiating the operating speed for communication between the first Ethernet device and the second Ethernet device over the link; (E) if, at (C), the link status for the link between the first Ethernet device and the second Ethernet device is up at the selected speed of 2.5 GBPS, then determining channel characteristics at the selected speed of 2.5 GBPS; (F) if, at (E), the determined channel characteristics are acceptable at the selected speed of 2.5 GBPS, then setting the operating speed as the selected speed of 2.5 GBPS; (G) if, at (E), the determined channel characteristics are not acceptable at the selected speed of 2.5 GBPS, then end negotiating the operating speed for communication between the first Ethernet device and the second Ethernet device over the link; (H) if, at (B), the second Ethernet device does not support the selected speed of 2.5 GBPS, then end negotiating the operating speed for communication between the first Ethernet device and the second Ethernet device over the link; (vi) if, at (iv), the link status for the link between the first Ethernet device and the second Ethernet device is up at the selected speed of 5 GBPS, then determining channel characteristics at the selected speed of 5 GBPS; (vii) if, at (vi), the determined channel characteristics are acceptable at the selected speed of 5 GBPS, then setting the operating speed as the selected speed of 5 GBPS; (viii) if, at (vi), the determined channel characteristics are not acceptable at the selected speed of 5 GBPS, then: (AA) setting the selected speed of the first Ethernet device at 2.5 GBPS; (BB) determining whether the second Ethernet device supports the selected speed of 2.5 GBPS; (CC) if, at (BB), the second Ethernet device supports the selected speed of 2.5 GBPS, then setting the selected speed of the second Ethernet device at 2.5 GBPS and determining a link status for the link between the first Ethernet device and the second Ethernet device at the selected speed of 2.5 GBPS; (DD) if, at (CC), the link status for the link between the first Ethernet device and the second Ethernet device is down at the selected speed of 2.5 GBPS, then end negotiating the operating speed for communication between the first Ethernet device and the second Ethernet device over the link; (EE) if, at (CC), the link status for the link between the first Ethernet device and the second Ethernet device is up at the selected speed of 2.5 GBPS, then determining channel characteristics at the selected speed of 2.5 GBPS; (FF) if, at (EE), the determined channel characteristics are acceptable at the selected speed of 2.5 GBPS, then setting the operating speed as the selected speed of 2.5 GBPS; (GG) if, at (EE), the determined channel characteristics are not acceptable at the selected speed of 2.5 GBPS, then end negotiating the operating speed for communication between the first Ethernet device and the second Ethernet device over the link; (HH) if, at (BB), the second Ethernet device does not support the selected speed of 2.5 GBPS, then end negotiating the operating speed for communication between the first Ethernet device and the second Ethernet device over the link; (ix) if, at (ii), the second Ethernet device does not support the selected speed of 5 GBPS, then: (AAA) setting the selected speed of the first Ethernet device at 2.5 GBPS; (BBB) determining whether the second Ethernet device supports the selected speed of 2.5 GBPS; (CCC) if, at (BBB), the second Ethernet device supports the selected speed of 2.5 GBPS, then setting the selected speed of the second Ethernet device at 2.5 GBPS and determining a link status for the link between the first Ethernet device and the second Ethernet device at the selected speed of 2.5 GBPS; (DDD) if, at (CCC), the link status for the link between the first Ethernet device and the second Ethernet device is down at the selected speed of 2.5 GBPS, then end negotiating the operating speed for communication between the first Ethernet device and the second Ethernet device over the link; (EEE) if, at (CCC), the link status for the link between the first Ethernet device and the second Ethernet device is up at the selected speed of 2.5 GBPS, then determining channel characteristics at the selected speed of 2.5 GBPS; (FFF) if, at (EEE), the determined channel characteristics are acceptable at the selected speed of 2.5 GBPS, then setting the operating speed as the selected speed of 2.5 GBPS; (GGG) if, at (EEE), the determined channel characteristics are not acceptable at the selected speed of 2.5 GBPS, then end negotiating the operating speed for communication between the first Ethernet device and the second Ethernet device over the link; (HHH) if, at (BBB), the second Ethernet device does not support the selected speed of 2.5 GBPS, then end negotiating the operating speed for communication between the first Ethernet device and the second Ethernet device over the link; (d) if, at (b), the link status for the link between the first Ethernet device and the second Ethernet device is up at the selected speed of 10 GBPS, then determining channel characteristics at the selected speed of 10 GBPS; (e) if, at (d), the determined channel characteristics are acceptable at the selected speed of 10 GBPS, then setting the operating speed as the selected speed of 10 GBPS; (f) if, at (d), the determined channel characteristics are not acceptable at the selected speed of 10 GBPS, then: (fi) setting the selected speed of the first Ethernet device at 5 GBPS; (fii) determining whether the second Ethernet device supports the selected speed of 5 GBPS; (fiii) if the second Ethernet device supports the selected speed of 5 GBPS, then setting the selected speed of the second Ethernet device at 5 GBPS; (fly) determining a link status for the link between the first Ethernet device and the second Ethernet device at the selected speed of 5 GBPS; (fv) if, at (fiv), the link status for the link between the first Ethernet device and the second Ethernet device is down at the selected speed of 5 GBPS, then: (fA) setting the selected speed of the first Ethernet device at 2.5 GBPS; (fB) determining whether the second Ethernet device supports the selected speed of 2.5 GBPS; (fC) if, at (fB), the second Ethernet device supports the selected speed of 2.5 GBPS, then setting the selected speed of the second Ethernet device at 2.5 GBPS and determining a link status for the link between the first Ethernet device and the second Ethernet device at the selected speed of 2.5 GBPS; (fD) if, at (fC), the link status for the link between the first Ethernet device and the second Ethernet device is down at the selected speed of 2.5 GBPS, then end negotiating the operating speed for communication between the first Ethernet device and the second Ethernet device over the link; (fE) if, at (fC), the link status for the link between the first Ethernet device and the second Ethernet device is up at the selected speed of 2.5 GBPS, then determining channel characteristics at the selected speed of 2.5 GBPS; (fF) if, at (fE), the determined channel characteristics are acceptable at the selected speed of 2.5 GBPS, then setting the operating speed as the selected speed of 2.5 GBPS; (fG) if, at (fE), the determined channel characteristics are not acceptable at the selected speed of 2.5 GBPS, then end negotiating the operating speed for communication between the first Ethernet device and the second Ethernet device over the link; (fH) if, at (fB), the second Ethernet device does not support the selected speed of 2.5 GBPS, then end negotiating the operating speed for communication between the first Ethernet device and the second Ethernet device over the link; (fvi) if, at (fiv), the link status for the link between the first Ethernet device and the second Ethernet device is up at the selected speed of 5 GBPS, then determining channel characteristics at the selected speed of 5 GBPS; (fvii) if, at (fvi), the determined channel characteristics are acceptable at the selected speed of 5 GBPS, then setting the operating speed as the selected speed of 5 GBPS; (fviii) if, at (fvi), the determined channel characteristics are not acceptable at the selected speed of 5 GBPS, then: (fAA) setting the selected speed of the first Ethernet device at 2.5 GBPS; (fBB) determining whether the second Ethernet device supports the selected speed of 2.5 GBPS; (fCC) if, at (fBB), the second Ethernet device supports the selected speed of 2.5 GBPS, then setting the selected speed of the second Ethernet device at 2.5 GBPS and determining a link status for the link between the first Ethernet device and the second Ethernet device at the selected speed of 2.5 GBPS; (fDD) if, at (fCC), the link status for the link between the first Ethernet device and the second Ethernet device is down at the selected speed of 2.5 GBPS, then end negotiating the operating speed for communication between the first Ethernet device and the second Ethernet device over the link; (fEE) if, at (fCC), the link status for the link between the first Ethernet device and the second Ethernet device is up at the selected speed of 2.5 GBPS, then determining channel characteristics at the selected speed of 2.5 GBPS; (fFF) if, at (fEE), the determined channel characteristics are acceptable at the selected speed of 2.5 GBPS, then setting the operating speed as the selected speed of 2.5 GBPS; (fGG) if, at (fEE), the determined channel characteristics are not acceptable at the selected speed of 2.5 GBPS, then end negotiating the operating speed for communication between the first Ethernet device and the second Ethernet device over the link; (fHH) if, at (fBB), the second Ethernet device does not support the selected speed of 2.5 GBPS, then end negotiating the operating speed for communication between the first Ethernet device and the second Ethernet device over the link; (fix) if, at (fii), the second Ethernet device does not support the selected speed of 5 GBPS, then: (fAAA) setting the selected speed of the first Ethernet device at 2.5 GBPS; (fBBB) determining whether the second Ethernet device supports the selected speed of 2.5 GBPS; (fCCC) if, at (fBBB), the second Ethernet device supports the selected speed of 2.5 GBPS, then setting the selected speed of the second Ethernet device at 2.5 GBPS and determining a link status for the link between the first Ethernet device and the second Ethernet device at the selected speed of 2.5 GBPS; (fDDD) if, at (fCCC), the link status for the link between the first Ethernet device and the second Ethernet device is down at the selected speed of 2.5 GBPS, then end negotiating the operating speed for communication between the first Ethernet device and the second Ethernet device over the link; (fEEE) if, at (fCCC), the link status for the link between the first Ethernet device and the second Ethernet device is up at the selected speed of 2.5 GBPS, then determining channel characteristics at the selected speed of 2.5 GBPS; (fFFF) if, at (fEEE), the determined channel characteristics are acceptable at the selected speed of 2.5 GBPS, then setting the operating speed as the selected speed of 2.5 GBPS; (fGGG) if, at (fEEE), the determined channel characteristics are not acceptable at the selected speed of 2.5 GBPS, then end negotiating the operating speed for communication between the first Ethernet device and the second Ethernet device over the link; (fHHH) if, at (fBBB), the second Ethernet device does not support the selected speed of 2.5 GBPS, then end negotiating the operating speed for communication between the first Ethernet device and the second Ethernet device over the link.

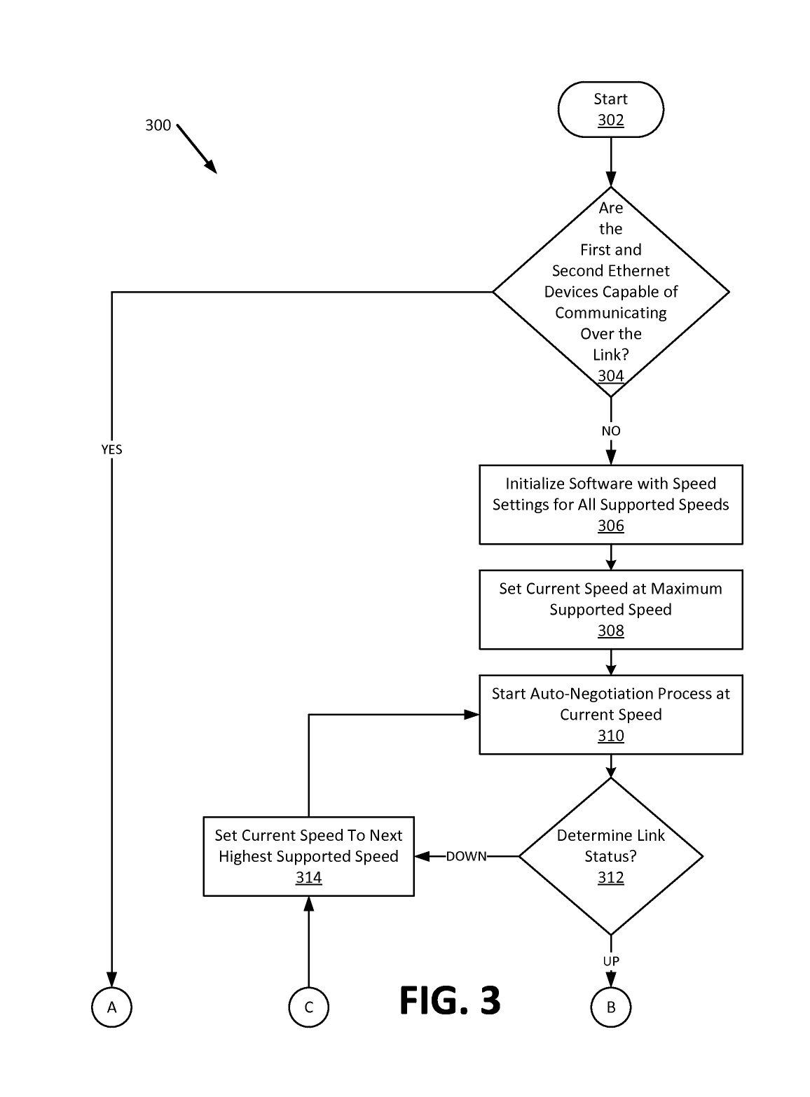

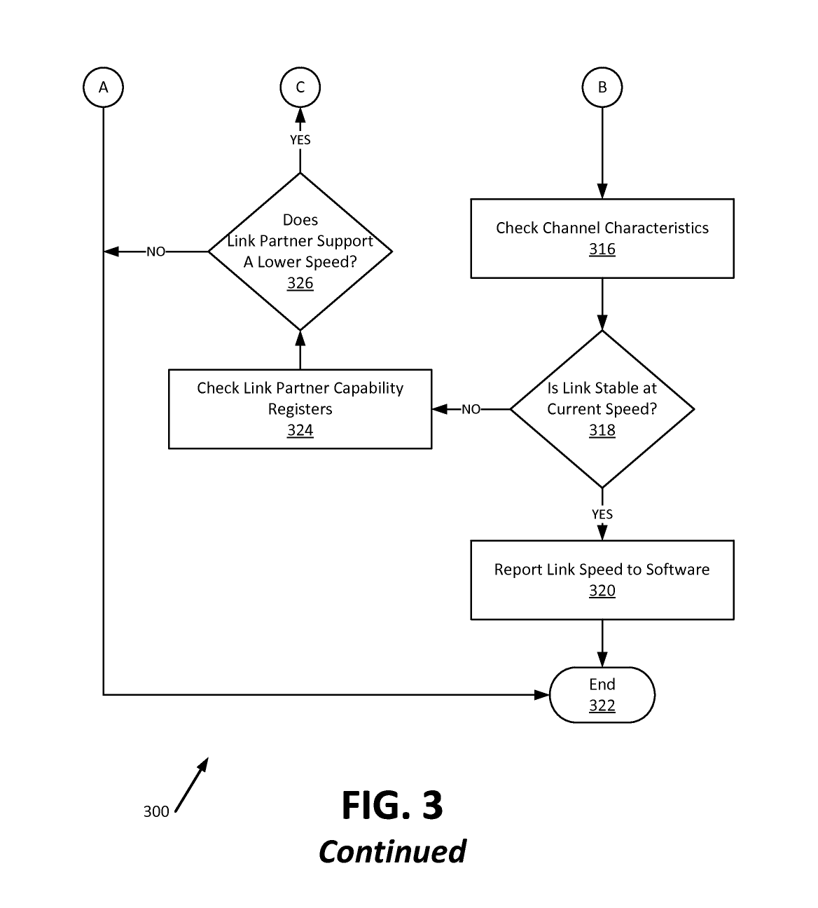

FIG. 3 illustrates an example flow diagram of a method for multiple gigabit Ethernet link recovery according to another implementation of the invention. The described method 300 begins at 302. At 304, a preliminary determination is made as to whether the first and second Ethernet devices are capable of communicating over the link at their present settings. If so, then there is no need to make any changes to the system, so the process goes to 322, where it ends. If; however, at 304 it is determined that the first and second Ethernet devices are not capable of communicating over the link at their present settings, then the process 300 goes to 306, where software that controls the system is initialized with speed settings for all supported speeds for both, the first Ethernet device and the second Ethernet device. For example, the software could be initialized to register that the first Ethernet device can operate at five separate speeds (e.g., 100 MBPS, 1 GBPS, 2.5 GBPS, 5 GBPS and 10 GBPS) and that the second Ethernet device can also operate at either two separate speeds (e.g., 1 GBPS and 10 GBPS) or at five separate speeds (e.g., 100 MBPS, 1 GBPS, 2.5 GBPS, 5 GBPS and 10 GBPS). The process 300 continues to 308, where a “current speed” setting for the system is set at the maximum supported speed for either of the first Ethernet device or the second Ethernet device. At 310, an auto-negotiation process begins for determining an acceptable communication speed between the first Ethernet device and the second Ethernet device over the link. The auto-negotiation process begins at the current speed setting, which is initially the maximum supported speed for either of the first Ethernet device or the second Ethernet device.

At 312, a decision is made about link status. Generally, this involves determining whether the first Ethernet device and the second Ethernet device can communicate with one another over the link at the current speed or whether there is continuity in the link. If, at 312, the link is “up” (i.e., operational) at the current speed, then the process 300 moves on to 316, where channel characteristics are checked. Generally, channel characteristics are determined for the communication channel between the first Ethernet device and the second Ethernet device. Generally, these characteristics go to the quality of the communication channel and can include, for example, Signal-to-Noise-Ratio (SNR), low-density parity-check (LDPC) errors, cyclic redundancy check (CRC) errors, symbol errors, frame check sequence (FCS) errors, collision fragments, line or system side receive or transmit bad packet counters, transmit total bytes and received total bytes used to calculate and store transmit and receive packet error rates (PERs), and the like. Generally, at 316, threshold levels are set for the channel characteristics and at 318 it is determined whether the specific characteristic falls within an acceptable level as compared to the threshold. If, at 318, the characteristics are within acceptable levels or if a sufficient number of the characteristics are within acceptable levels, then at 320 the current link speed is reported to the system and the system is operated at the current speed. However, if at 318 the channel characteristics fall outside acceptable levels as compared to the threshold (i.e., the link is not stable at the current speed), then the process goes to 324. At 324, the registers that were initialized at 306 are checked to see what speeds are supported by the link partners. Also, the communication mode (full duplex or half duplex) of the link partner may be checked when discerning link partner capability. At 326, it is determined whether the link partners can support a lower speed. If they can, then at 314 the link partners are set at their next highest speed (i.e., their speeds are lowered), the current speed is set at the lowered speed, and the auto-negotiation process begins again at the lowered speeds at 310.

Returning to 312, if it is determined that the link is “down,” then at 314 the link partners are set at their next highest supported speed and the current speed is set to the next highest supported speed. For example, if the current speed was 10 GBPS, it is set at 314 to 5 GBPS. The process 300 then goes to 310, where the auto-negotiation process begins again at the lower speed.

The process 300 continues until the first Ethernet device and the second Ethernet device negotiate an operating speed for the link that is acceptable and has channel characteristics that fall within an acceptable range as compared to threshold values. In such an instance where the two Ethernet devices cannot negotiate an acceptable speed, the link may have to be replaced with a new material such as fiber optic cable, a Cat 6a cable, or the like, or other physical level changes made to the system.

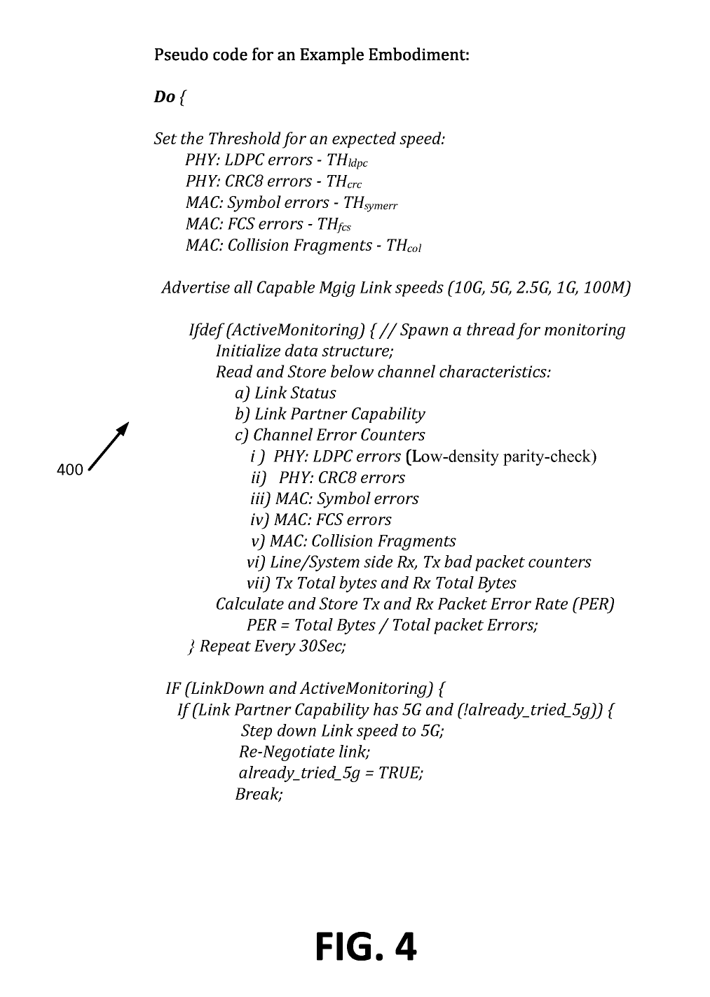

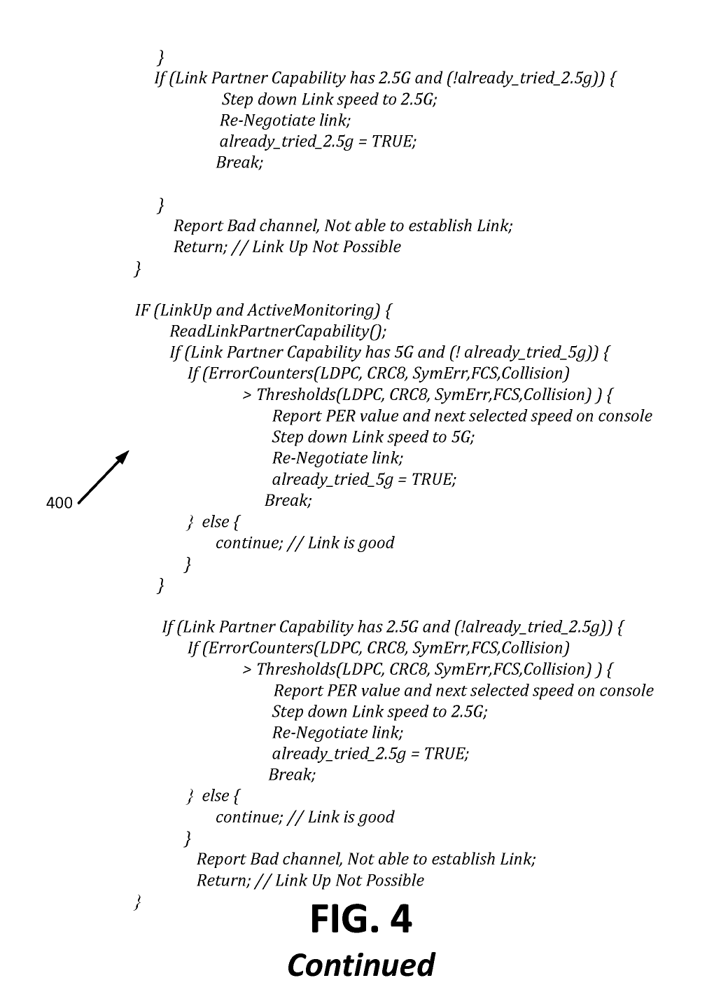

As noted, the process of FIG. 3 is controlled by computer-executable instructions that are stored on a computer-readable medium being executed by a processor. FIG. 4 is a non-limiting example of pseudocode 400 that can be implemented to perform the process described in relation to FIG. 3.

When the logical operations described herein are implemented in software, the process may execute on any type of computing architecture or platform. For example, referring to FIG. 5, an example computing device upon which embodiments of the invention may be implemented is illustrated. In particular, one or both of the first Ethernet device and the second Ethernet device can be associated with a computing device, such as processing unit 108 shown in FIG. 4. The processing unit 108 may include a bus or other communication mechanism for communicating information among various components of the processing unit 108. In its most basic configuration, processing unit 108 typically includes at least one processor 506 and system memory 504. Depending on the exact configuration and type of computing device, system memory 504 may be volatile (such as random access memory (RAM)), non-volatile (such as read-only memory (ROM), flash memory, etc.), or some combination of the two. This most basic configuration is illustrated in FIG. 5 by dashed line 502. The processor 506 may be a standard programmable processor that performs arithmetic and logic operations necessary for operation of the processing unit 108.

Processing unit 108 may have additional features/functionality. For example, processing unit 108 may include additional storage such as removable storage 508 and non-removable storage 510 including, but not limited to, magnetic or optical disks or tapes. Processing unit 108 may also contain network connection(s) 516 that allow the device to communicate with other devices. Processing unit 108 may also have input device(s) 514 such as a keyboard, mouse, touch screen, etc. Output device(s) 512 such as a display, speakers, printer, etc. may also be included. The additional devices may be connected to the bus in order to facilitate communication of data among the components of the processing unit 108. All these devices are well known in the art and need not be discussed at length here.

The processor 406 may be configured to execute program code encoded in tangible, computer-readable media. Computer-readable media refers to any media that is capable of providing data that causes the processing unit 108 (i.e., a machine) to operate in a particular fashion. Various computer-readable media may be utilized to provide instructions to the processor 506 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processor 406 may execute program code stored in the system memory 504. For example, the bus may carry data to the system memory 504, from which the processor 506 receives and executes instructions. The data received by the system memory 504 may optionally be stored on the removable storage 508 or the non-removable storage 510 before or after execution by the processor 506.

Processing unit 108 typically includes a variety of computer-readable media. Computer-readable media can be any available media that can be accessed by device 108 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by processing unit 108. Any such computer storage media may be part of processing unit 108.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed:

1. A method, comprising:
providing a first Ethernet device, wherein the first Ethernet device can be switched to be operable at any one of a plurality of speeds;
providing a second Ethernet device that can be switched to be operated at one of one or more speeds, wherein at least one of the one or more speeds of the second Ethernet device is the same as one of the plurality of speeds of the first Ethernet device;
providing a link between the first Ethernet device and the second Ethernet device, wherein at least a portion of the link comprises a Category 5 Enhanced (Cat 5e) cable; and
negotiating an operating speed for communication between the first Ethernet device and the second Ethernet device over the link, wherein the operating speed is one of the any one of the plurality of speeds of the first Ethernet device and one of the one or more speeds of the second Ethernet device.

2. The method of claim 1, wherein providing the first Ethernet device comprises providing an Ethernet transceiver.

3. The method of claim 1, wherein providing the first Ethernet device, wherein the first Ethernet device can be switched to be operable at any one of a plurality of speeds comprises providing the first Ethernet device that can be switched to be operable at any one of the plurality of speeds through software, wherein at least a portion of the software is executing on the first Ethernet device.

4. The method of claim 3, wherein the first Ethernet device can be switched to be operable at any one of 100 Mega-Bits per second (MBPS), 1 Giga-Bit per second (GBPS), 2.5 GBPS, 5 GBPS and 10 GBPS speed.

5. The method of claim 1, wherein providing the second Ethernet device comprises providing an Ethernet transceiver.

6. The method of claim 1, wherein providing the second Ethernet device that can be switched to be operated at one of the one or more speeds comprises providing the second Ethernet device that can be switched to be operated at one of the one or more speeds through software, wherein at least a portion of the software is executing on the first or the second Ethernet device.

7. The method of claim 6, wherein the second Ethernet device can be switched to be operated at one of 100 Mega-Bits per second (MBPS), 1 Giga-Bit per second (GBPS), 2.5 GBPS, 5 GBPS and 10 GBPS speed.

8. The method of claim 1, wherein providing the link between the first Ethernet device and the second Ethernet device, wherein at least a portion of the link comprises a Category 5 Enhanced (Cat 5e) cable comprises providing a 100 meter or less portion of the link comprised of Cat 5e cable.

9. The method of claim 1, wherein negotiating an operating speed for communication between the first Ethernet device and the second Ethernet device over the link comprises the following:
(a) setting the first Ethernet device at a selected speed, wherein the selected speed is one of the plurality of speeds of the first Ethernet device;
(b) determining one or more of a link status, whether the second Ethernet device can operate at the selected speed, and channel characteristics at the selected speed;
(c) making a decision to set the operating speed as the selected speed based on the one or more of the determinations; or
(d) selecting another of the one or more of the plurality of speeds of the first Ethernet device as the selected speed and repeating (a)-(c), above.

10. The method of claim 1, wherein negotiating the operating speed for communication between the first Ethernet device and the second Ethernet device over the link comprises:
(a) setting the first Ethernet device at a selected speed of 10 GBPS;
(b) determining a link status for the link between the first Ethernet device and the second Ethernet device at the selected speed of 10 GBPS;
(c) if, at (b), the link status for the link between the first Ethernet device and the second Ethernet device is down at the selected speed of 10 GBPS, then
(i) setting the first Ethernet device and the second Ethernet device at a selected speed less than 10 GBPS and checking link status at the selected speed less than 10 GBPS to determine if an acceptable link status is achieved; and
(ii) if an acceptable link status can be achieved between the first Ethernet device and the second Ethernet device at the selected speed less than 10 GBPS, then checking one or more channel characteristics and if the one or more channel characteristics are acceptable, then operating the first Ethernet device and the second Ethernet device at the selected speed less than 10 GBPS
(iii) if an acceptable links status and acceptable channel characteristics cannot be achieved at the selected speed less than 10 GBPS, then end negotiating the operating speed for communication between the first Ethernet device and the second Ethernet device over the link;
(d) if, at (b), the link status for the link between the first Ethernet device and the second Ethernet device is acceptable at the selected speed of 10 GBPS, then checking cannel characteristics between the first Ethernet device and the second Ethernet device over the link at 10 GBPS and if the one or more channel characteristics are acceptable, then operating the first Ethernet device and the second Ethernet device at the selected speed of 10 GBPS, else go to (i), above.

11. The method of claim 10, wherein said channel characteristics comprising one or more of Signal-to-Noise-Ratio (SNR), low-density parity-check (LDPC) errors, cyclic redundancy check (CRC) errors, symbol errors, frame check sequence (FCS) errors, collision fragments, line or system side receive or transmit bad packet counters, transmit total bytes and received total bytes used to calculate and store transmit and receive packet error rates (PERs).

12. A system comprised of:
a first Ethernet device, wherein the first Ethernet device can be switched to be operable at any one of a plurality of speeds;
a second Ethernet device that can be switched to be operated at one of one or more speeds;
a link between the first Ethernet device and the second Ethernet device, wherein at least a portion of the link comprises a Category 5 Enhanced (Cat 5e) cable; and
a processor, wherein the processor is communicatively coupled with at least one of the first Ethernet device and the second Ethernet device, said processor executing computer-readable instructions to negotiate an operating speed for communication between the first Ethernet device and the second Ethernet device over the link, wherein the operating speed is one of the any one of the plurality of speeds of the first Ethernet device and one of the one or more speeds of the second Ethernet device.

13. The system of claim 12, wherein the first Ethernet device comprises an Ethernet transceiver and the processor is associated with the Ethernet transceiver.

14. The system of claim 12, wherein the processor executes computer-readable instructions to switch the first Ethernet device to be operable at any one of the plurality of speeds.

15. The system of claim 14, wherein the first Ethernet device can be switched to be operable at any one of 100 Mega-Bits per second (MBPS), 1 Giga-Bit per second (GBPS), 2.5 GBPS, 5 GBPS and 10 GBPS speed.

16. The system of claim 12, wherein the second Ethernet device comprises an Ethernet transceiver.

17. The system of claim 12, wherein the processor executes computer-readable instructions to switch the second Ethernet device to be operable at one of the one or more speeds.

18. The system of claim 17, wherein the second Ethernet device can be switched to be operable at one of 100 Mega-Bits per second (MBPS), 1 Giga-Bit per second (GBPS), 2.5 GBPS, 5 GBPS and 10 GBPS speed.

19. The system of claim 12, wherein a 100 meter or less portion of the link is comprised of Cat 5e cable.

20. The system of claim 12, wherein the processor executing computer-readable instructions to negotiate an operating speed for communication between the first Ethernet device and the second Ethernet device over the link comprises the processor executing computer-readable instructions to perform the following:
(a) set the first Ethernet device at a selected speed, wherein the selected speed is one of the plurality of speeds of the first Ethernet device;
(b) determine one or more of a link status, whether the second Ethernet device can operate at the selected speed, and channel characteristics at the selected speed;
(c) make a decision to set the operating speed as the selected speed based on the one or more of the determinations; or
(d) select another of the one or more of the plurality of speeds of the first Ethernet device as the selected speed and repeat (a)-(c), above.

21. The system of claim 20, wherein the selected speed of the first Ethernet device and the selected another of the one or more of the plurality of speeds of the first Ethernet device are selected in order from 10 Giga-Bits per second (GBPS) to 5 GBPS to 2.5 GBPS.

22. The system of claim 20, wherein said channel characteristics comprising one or more of Signal-to-Noise-Ratio (SNR), low-density parity-check (LDPC) errors, cyclic redundancy check (CRC) errors, symbol errors, frame check sequence (FCS) errors, collision fragments, line or system side receive or transmit bad packet counters, transmit total bytes and received total bytes used to calculate and store transmit and receive packet error rates (PERs).

23. A computer-readable medium comprising computer-executable instructions thereon that when executed cause a processor to negotiate an operating speed for communication between a first Ethernet device that can be switched to be operable at any one of a plurality of speeds and a second Ethernet device that can be switched to be operated at one of one or more speeds, said first Ethernet device and said second Ethernet device connected over a link, wherein at least a portion of the link comprises a Category 5 Enhanced (Cat 5e) cable, said computer-executable instructions comprising:
(a) setting the first Ethernet device at a selected speed, wherein the selected speed is one of the plurality of speeds of the first Ethernet device;
(b) determining one or more of a link status, whether the second Ethernet device can operate at the selected speed, and channel characteristics at the selected speed;
(c) making a decision to set the operating speed as the selected speed based on the one or more of the determinations; or
(d) selecting another of the one or more of the plurality of speeds of the first Ethernet device as the selected speed and repeat (a)-(c), above.

24. The computer-readable medium of claim 23, wherein the selected speed of the first Ethernet device and the selected another of the one or more of the plurality of speeds of the first Ethernet device are selected in order from 10 Giga-Bits per second (GBPS) to 5 GBPS to 2.5 GBPS.

25. The computer-readable medium of claim 23, wherein said channel characteristics comprising one or more of Signal-to-Noise-Ratio (SNR), low-density parity-check (LDPC) errors, cyclic redundancy check (CRC) errors, symbol errors, frame check sequence (FCS) errors, collision fragments, line or system side receive or transmit bad packet counters, transmit total bytes and received total bytes used to calculate and store transmit and receive packet error rates (PERs).
